(19) United States
(12) Patent Application Publication
(10) Pub. No.: US 2026/0159689 A1
(43) Pub. Date: Jun. 11, 2026

(54) Non-Tin Catalyst System for Curable Silicone Compositions and Silane Modified Polymer Compositions

(71) Applicant: Henkel AG & Co. KGaA, Duesseldorf (DE)

(72) Inventors: Christy Lee Stine, Royal Oak, MI (US); James Anthony Willis, Madison Heights, MI (US); Alfred Decato, Ashtabula, OH (US); Abhijit Hirekerur, Pune (IN)

(21) Appl. No.: 19/537,815

(22) Filed: Feb. 12, 2026

Related U.S. Application Data
(63) Continuation of application No. PCT/US2024/042684, filed on Aug. 16, 2024.
(60) Provisional application No. 63/578,210, filed on Aug. 23, 2023.
(60) Provisional application No. 63/667,280, filed on Jul. 3, 2024.

(51) Int. Cl. C08L 83/06

(52) U.S. Cl. CPC C08L 83/06; C08L 2314/00

(57) ABSTRACT

Disclosed is a catalyst combination comprising at least two catalysts, useful to help cure moisture curable silicone polymer composition, which may include a first catalyst comprising titanium (IV) diisopropoxide bis(acetylacetonate); and a second catalyst comprising titanium (IV) tert-butoxide; wherein the described catalyst combination is useful in moisture curable silicone polymer reactions, optionally wherein the curable material comprises a moisture curable organosiloxane, a moisture curable silane modified polymer or a combination thereof and preferably the catalyst combination, and the composition comprising the catalyst combination, is free of tin.

### FIELD

The present disclosure relates generally to a non-tin catalyst system for curable silicone compositions and the compositions formed therewith.

### BRIEF DESCRIPTION OF RELATED TECHNOLOGY

Curable silicone polymers and compositions are useful as adhesives, sealants, releasing coatings, conformal coatings, potting compounds, encapsulants, and the like, in a broad range of applications including aerospace, automotive, construction, highway, electronic device and package assembly, appliance assembly and consumer uses. Typically, curable silicone polymers and compositions used in these applications have been tailored to provide the strength, toughness, cure speed, modulus, elongation, and resistance to high temperatures and humidity required by that application.

Silicone compositions as room-temperature-vulcanizing (RTV) sealants are described in U.S. Pat. Nos. 4,514,529; 4,673,750; 4,735,979; and 4,847,396; and International Publication No. WO9319130. One drawback to the RTV silicone compositions is their slow rate of cure, which is commercially unacceptable for certain applications, such as sealing electronic modules, where high volume production may depend upon cure rate. Accordingly, silicone compositions with improved cure rates are desirable.

Silane modified polymers are the reaction products of urethanes and siloxy (—Si(Rₙ)(OR)₃₋ₙ containing components. Silane modified polymers are useful in compositions as adhesives, sealants, conformal coatings, potting compounds, encapsulants, and the like, in a broad range of applications. Typically, silane modified polymers used in these applications have been tailored to provide the strength, toughness, cure speed, modulus, elongation, and resistance to high temperatures and humidity required by that application.

Tin based catalysts have traditionally been used to improve cure rate of both silicone compositions and silane modified polymer compositions. However, tin-based catalysts are increasingly being more strictly regulated. Titanium based catalysts have been proposed. However, compositions using some titanium-based catalysts such as titanium butoxide ae known to have a limited depth of cure compared to tin catalysts, poor shelf stability and poor compatibility with amine components in the composition. Compositions using other titanium catalysts such as titanium diisopropoxide bis(acetylacetonate) are known to have poor skin over time and poor tensile properties. A tin free catalyst system that can provide the properties of tin catalysts remains desirable.

### SUMMARY

One aspect of the disclosure provides a catalyst combination useful in moisture curable silicone polymer reactions.

Another aspect of this disclosure is a catalyst combination including a first catalyst comprising titanium (IV) diisopropoxide bis(acetylacetonate); and a second catalyst comprising titanium (IV) tert-butoxide;

Another aspect of this disclosure provides a catalyst combination useful in moisture curable silicone polymer reactions that is free of tin.

Another aspect of this disclosure is a curable composition, comprising a curable material selected from a moisture curable organosiloxane, a moisture curable silane modified polymer and a combination thereof; a first catalyst comprising titanium (IV) diisopropoxide bis(acetylacetonate); and a second catalyst comprising titanium (IV) tert-butoxide.

### DETAILED DESCRIPTION

The singular forms “a”, “an” and “the” include plural referents unless the context clearly dictates otherwise.

About or “approximately” as used herein in connection with a numerical value refer to the numerical value ±10%, preferably ±5% and more preferably ±1% or less.

At least one, as used herein, means 1 or more, i.e., 1, 2, 3, 4, 5, 6, 7, 8, 9, or more. With reference to an ingredient, the indication refers to the type of ingredient and not to the absolute number of molecules. “At least one polymer” thus means, for example, at least one type of polymer, i.e., that one type of polymer or a mixture of several different polymers may be used.

The terms “comprising”, “comprises” and “comprised of” as used herein are synonymous with “including”, “includes”, “containing” or “contains”, and are inclusive or open-ended and do not exclude additional, non-recited members, elements or method steps.

Unless specified otherwise, the recitation of numerical end points includes all numbers and fractions subsumed within the respective ranges, as well as the recited end points.

Unless otherwise defined, all terms used in the present disclosure, including technical and scientific terms, have the meaning as commonly understood by one of the ordinary skilled in the art.

Preferred and preferably are used frequently herein to refer to embodiments of the disclosure that may afford particular benefits, under certain circumstances. However, the recitation of one or more preferable or preferred embodiments does not imply that other embodiments are not useful and is not intended to exclude those other embodiments from the scope of the disclosure.

The molecular weights given in the present text refer to number average molecular weights (Mn), unless otherwise stipulated. Molecular weight data can be obtained by gel permeation chromatography (GPC) calibrated against polystyrene standards in accordance with DIN 55672-1:2007-08 at 35° C., unless otherwise stipulated. The weight average molecular weight Mw can be determined by GPC, as described for Mₙ.

As used herein a curable, one component (1K) composition is a singular formulation that has sufficient commercial stability, for example months to years, to be prepared, warehoused and shipped to, and stored by, an end-user. The 1K composition can be used without adding any additional components and will crosslink or cure when exposed to suitable conditions. As used herein a two component (2K) composition has two or more components. Each of the components is prepared, warehoused and shipped separately from the other components. The components are mixed immediately prior to use. Mixing of the components starts a cure reaction so commercial storage after mixing is not possible.

As used herein for each of the various embodiments, the following definitions apply:

Unless otherwise specifically defined, (meth)acrylate refers to at least one of acrylate and methacrylate. A “vinyl group” refers to (CH₂═CH—). A “(meth)acryloyl” refers to at least one of acryloyl and methacryloyl, an “acryloyl group” refers to (CH₂═CHCO—), and a “methacryloyl group” refers to (CH₂═C(CH₃)CO—).

Unless otherwise specifically defined, “acyl” refers to the general formula —C(O)alkyl.

Unless otherwise specifically defined, “acyloxy” refers to the general formula —O-acyl.

Unless otherwise specifically defined, “alcohol” refers to the general formula alkyl-OH.

Unless otherwise specifically defined, “alkenyl” or “lower alkenyl” refers to a linear, branched or cyclic carbon chain having from 1 to about 16 carbon atoms, and advantageously about 1 to about 6 carbon atoms, and at least one double bond between carbon atoms in the chain. Examples include, for example, ethylene, allene, butene, butadiene, hexene, hexadiene, 5,5-dimethyl-1-hexene and cyclohexene. Unless otherwise specifically limited an alkenyl group can be unsubstituted, singly substituted, or multiply substituted, with substituent groups in any possible position.

Unless otherwise specifically defined, “alkoxy” refers to the general formula —O-alkyl.

Unless otherwise specifically defined, “alkyl” refers to a linear, branched or cyclic alkyl group having from 1 to about 9 carbon atoms including, for example, methyl, ethyl, propyl, butyl, hexyl, octyl, isopropyl, isobutyl, tert-butyl, cyclopropyl, cyclohexyl, cyclooctyl, vinyl and allyl. Unless otherwise specifically defined, an alkyl group can be saturated or unsaturated and substituted or unsubstituted. Unless otherwise specifically limited, a cyclic alkyl group includes monocyclic, bicyclic and polycyclic rings, for example norbornyl, adamantyl and related terpenes.

Unless otherwise specifically defined, “alkynyl” or “lower alkynyl” refers to a linear, branched or cyclic carbon chain having from 1 to about 16 carbon atoms, and advantageously about 1 to about 6 carbon atoms, and at least one triple bond between carbon atoms in the chain. Examples include, for example, ethyne, butyne, and hexyne.

Unless otherwise specifically limited an alkynyl group can be unsubstituted, singly substituted, or multiply substituted, with substituent groups in any possible position.

Unless otherwise specifically defined, an aromatic ring is an unsaturated ring structure having about 5 to about 6 ring members and including only carbon as ring atoms. Unless otherwise specifically defined, an aromatic ring can be substituted or unsubstituted.

Unless otherwise specifically defined, “aryl” refers to an aromatic ring system substituted or unsubstituted, that includes only carbon as ring atoms, for example phenyl, biphenyl or naphthyl.

Unless otherwise specifically defined, “halogen” refers to an atom selected from fluorine, chlorine, bromine and iodine.

Room temperature refers a temperature of about 25° C.

Unless otherwise specifically limited the term substituted means substituted by at least one below described substituent group in any possible position or positions. Substituent groups for the above moieties useful in the disclosed compounds are those groups that do not significantly diminish the biological activity of the disclosed compound. Substituent groups that do not significantly diminish the desired activity of the disclosed compound include, for example, H, halogen, N₃, NCS, CN, NO₂, NX₁X₂, OX₃, C(X₄)₃, OAc, O-acyl, O-aroyl, NH-acyl, NH-aroyl, NHCOalkyl, CHO, C(halogen)₃, COOX₄, SO₃H, PO₃H₂, SO₂NX₁X₂, CONX₁X₂, C(O)CF₃, alkyl, alcohol, alkoxy, alkylmercapto, alkylamino, alkaryl, di-alkylamino, sulfonamide or thioalkoxy wherein X₁ and X₂ each independently comprise H or alkyl, or X₁ and X₂ together comprise part of a heterocyclic ring having about 4 to about 7 ring members and optionally one additional heteroatom selected from O, N or S, or X₁ and X₂ together comprise part of an imide ring having about 5 to about 6 members and X₄ comprises H, alkyl, loweralkylhydroxy, or alkyl-NX₁X₂. Unless otherwise specifically limited, a substituent group may be in any possible position or any possible positions if multiply substituted; additionally, the term may also include a hetero atom such as O or N interrupting the C₁₋₁₈ alkyl chain.

The term “aliphatic” means saturated or unsaturated, straight, branched or cyclic hydrocarbon groups;

The term “oligomer” means a defined, small number of repeating monomer units such as 10-25,000 units, and desirably 10-100 units which have been polymerized to form a molecule and is a subset of the term polymer; the term “polymer” any polymerized product greater in chain length and molecular weight than the oligomer, i.e., or degrees of polymerization greater than 25,000.

“One or more”, as used herein, relates to at least one and comprises 1, 2, 3, 4, 5, 6, 7, 8, 9 or more of the referenced species. Similarly, “at least one” means one or more, i.e., 1, 2, 3, 4, 5, 6, 7, 8, 9 or more. “At least one”, as used herein in relation to any component, refers to the number of chemically different molecules, i.e., to the number of different types of the referenced species, but not to the total number of molecules. For example, “at least one polyol” means that at least one type of molecule falling within the definition for a polyol is used but that also two or more different polyol types falling within this definition can be present but does not mean that only one type of said polyol is necessarily present.

The disclosed compounds include any and all isomers and stereoisomers. In general, unless otherwise explicitly stated the disclosed materials and processes may be alternately formulated to comprise, consist of, or consist essentially of, any appropriate components, moieties or steps herein disclosed. The disclosed materials and processes may additionally, or alternatively, be formulated so as to be devoid, or substantially free, of any components, materials, ingredients, adjuvants, moieties, species and steps used in the prior art compositions or that are otherwise not necessary to the achievement of the function and/or objective of the present disclosure.

Unless explicitly indicated otherwise, all percentages that are cited in connection with the compositions described herein refer to weight percent (wt. %) with respect to final composition with all components, unless stated otherwise.

The catalyst system used in the disclosed compositions is a combination of a first catalyst selected from the group comprising titanium (IV) diisopropoxide bis(acetylacetonate); diisobutoxy-bisethylacetoacetatotitanate; diisopropoxy-bisethylacetoacetatotitanate and combinations thereof; and a second catalyst comprising titanium (IV) tert-butoxide. In some embodiments the catalyst system is a combination of a first catalyst comprising primarily titanium (IV) diisopropoxide bis(acetylacetonate) and a second catalyst comprising primarily titanium (IV) tert-butoxide. In some embodiments the catalyst system is a combination of a first catalyst consisting of titanium (IV) diisopropoxide bis(acetylacetonate) and a second catalyst consisting of titanium (IV) tert-butoxide. In some embodiments the catalyst system and composition comprising the catalyst system include little and preferably no catalysts comprising tin.

Titanium butoxide catalysts are known to provide cured compositions having a limited depth of cure, poor shelf stability and poor compatibility with amine components in the composition. Titanium diisopropoxide bis(acetylacetonate) catalysts are known to provide cured compositions having poor skin over time and poor tensile properties.

For silicone and silane modified polymer compositions use of the catalyst system having a combination of a first catalyst comprising titanium (IV) diisopropoxide bis(acetylacetonate) and a second catalyst comprising titanium (IV) tert-butoxide provides surprisingly improved properties compared to using the catalysts alone. A curable composition using the catalyst system having a combination of a first catalyst comprising titanium (IV) diisopropoxide bis(acetylacetonate) and a second catalyst comprising titanium (IV) tert-butoxide results in cured reaction products of that composition having deeper depth of cure, better shelf stability and better compatibility with amine components than using titanium butoxide catalysts alone and shorter skin over time and greater tensile properties than using titanium diisopropoxide bis(acetylacetonate).

It is preferred that the composition uses certain amounts of the first catalyst comprising titanium (IV) diisopropoxide bis(acetylacetonate) and the second catalyst comprising titanium (IV) tert-butoxide at certain ratios to each other to provide a preferred improvement in cured properties. In one embodiment the curable composition comprises 0.05 to 2.0 wt. % of the first catalyst and 0.05 to 2.0 wt. % of the second catalyst to achieve a wt. % ratio of 0.05:2.0 to 2.0 to 0.05. In one preferred embodiment the curable composition comprises 0.05 to 1.0 wt. % of the first catalyst and 0.05 to 1.0 wt. % of the second catalyst to achieve a wt. % ratio of 0.05:1.0 to 1.0 to 0.05. In another preferred embodiment the curable composition comprises 0.15:0.3 wt. % of the first catalyst and 0.3 to 0.8 wt. % of the second catalyst to achieve a wt. % ratio of 0.15:0.8 to 0.3 to 0.3 in the composition.

The catalyst system is useful with compositions comprising moisture curable organosiloxane (sometimes referred to as silicone) polymers and silane modified polymers. Siloxane or silicone polymers comprise can include polymers such as those within the general formula (I):

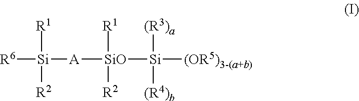

where
A represents a polymer or copolymer backbone, which can be any number of combinations of polyurethane, silicone, polyamide, polyether, polyester, and the like;
R1 and R2 may be the same or different and are monovalent hydrocarbyl groups having up to 10 carbon atoms, or halo- or cyano-substituted hydrocarbyl groups;
R3 and R4 may be the same or different monovalent hydrocarbyl groups and may contain an ethylenically unsaturated polymerizable double bond including a (meth)acryloyl group;
R5 is hydrogen, methyl, ethyl, isopropyl or —CH₂CH₂OCH₃; a is 0, 1, or 2; a+b is 1 or 2; and
R6 is a monovalent hydrocarbyl group or:

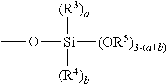

In some embodiments the silicones are those which have both moisture and photocuring capabilities. Such desirable silicones may conform to formula (II):

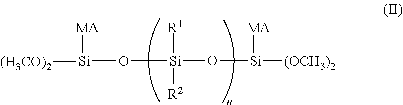

where MA is a (meth)acryloyl group (such as methacryoloxypropyl), R1 and R2 are as described above, and n is from 1 to 1,200.

In one embodiment, the silicone polymer includes a moisture-curing group selected from one or more of alkoxy, acetoxy, enoloxy, aryloxy, oxime, amino, N,N-dialkylamino, N,N-dialkylaminoxy, N-alkylamido, and combinations thereof.

The term “silicone-organic hybrid polymer” refers to polymers that comprise silicone blocks, (R2SiO)n, wherein the R groups are organic groups such as methyl or ethyl etc., in addition to significant organic block content and at least two hydroxy functional groups. The organic block content can comprise from 2 to 30 weight % based on the total weight of the silicone-organic hybrid polymer. As known to one of skill in the art an organic group is one that includes carbon in the group. The term “silicone-organic hybrid (meth)acrylate polymer” refers to silicone-organic hybrid polymers that have been fully or partially end-capped with (meth)acrylate functional groups. In one embodiment silicone-organic hybrid polymers can be prepared by reacting isocyanate functional (meth)acrylates with hydroxy functional groups of a silicone compound.

Silane modified polymers comprise at least one terminal group of the general formula (III)

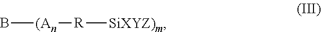

In some embodiments m is 1, 2, 3, 4, 5, 6 or more. In general formula (III), B is a polymer backbone, A is a divalent bonding group containing at least one heteroatom, R is selected from divalent hydrocarbon residues having 1 to 12 carbon atoms, X, Y, Z are, independently of one another, selected from the group consisting of a hydroxyl group and C1 to C8 alkyl, C1 to C8 alkoxy, and C1 to C8 acyloxy groups, wherein X, Y, Z are substituents directly bound with the Si atom or the two of the substituents X, Y, Z form a ring together with the Si atom to which they are bound, and at least one of the substituents X, Y, Z is selected from the group consisting a hydroxyl group, C1 to C8 alkoxy and C1 to C8 acyloxy groups, and n is 0 or 1.

B is an organic backbone. B will not be a siloxane backbone. B can be selected from polyurethane, polyether, polyester, poly(meth)acrylic acid ester, polyacrylate, polyacrylamide, polymethacrylamide, polyvinyl ester, polyolefin, alkyd resin, phenol resin, vinyl polymer, styrene-butadiene copolymer, as well as copolymers of one or more of the above backbones. Important properties of silane modified polymer and the curable composition, such as e.g., viscosity and elasticity, but also environmental resistance, can be influenced by the choice and the specific physical form of the polymer classes used for the backbone.

Polyurethanes, polyethers and polyesters, especially polyurethanes and polyethers, are preferably employed for the B backbone structure. In one embodiment polyethers that are based on polyethylene oxide and/or polypropylene oxide are employed due to considerations of availability and their excellent elastic properties.

In some embodiments, B is a polyether. Polyethers have a flexible and elastic structure, with which compositions having excellent elastic properties can be produced. Polyethers are not only flexible in their backbone, but at the same time strong. Further, polyethers are not attacked or decomposed by water and bacteria, in contrast to, e.g., polyesters, for example.

In this context, the divalent bonding group A comprising at least one heteroatom is understood to be a divalent chemical group which links the polymer backbone of the silane-terminated polymer with the residue R of the formula (I). For example, the divalent linking group A can be formed for example during the production of the alkoxysilane- and/or acyloxysilane-terminated polymer, for example as an amide or urethane group by the reaction of a polyether which is functionalized with hydroxy groups with an isocyanatosilane. The divalent linking group can be either capable or incapable of being differentiated from structural features occurring in the underlying polymer backbone. The latter is the case, for example, if it is identical with the linking points of the repeating units of the polymer backbone.

The index “n” corresponds to 0 (zero) or 1, i.e., the divalent linking group A links the polymer backbone with the residue R (n=1) or the polymer backbone is bound or linked directly with the residue R (n=0).

The divalent linking group A in the general formula (I) is preferably an oxygen atom or an —NR″— group, where R″ is selected from the group consisting of a hydrogen atom, and alkyl or aryl residues having 1 to 12 carbon atoms, or is a substituted or unsubstituted amide, carbamate, urethane, urea, amino, carboxylate, carbamoyl, amidino, carbonate, sulfonate or sulfinate group. Particularly preferred as linking group A are urethane and urea groups, which can be obtained by reacting certain functional groups of a prepolymer with an organosilane which carries a further functional group.

Urethane groups can be formed, for example, either when the polymer backbone comprises terminal hydroxy groups and isocyanatosilanes are used as a further component, or conversely when a polymer having terminal isocyanate groups is reacted with an alkoxysilane comprising terminal hydroxy groups. Similarly, urea groups can be obtained if a terminal primary or secondary amino group—either on the silane or on the polymer—is used, which reacts with a terminal isocyanate group that is present in the respective reactant. This means that either an aminosilane is reacted with a polymer having terminal isocyanate groups or a polymer that is terminally substituted with an amino group is reacted with an isocyanatosilane.

Urethane and urea groups advantageously increase the strength of the polymer backbone chains and of the overall crosslinked polymer.

The residue R is a divalent hydrocarbon residue having 1 to 12 carbon atoms. The hydrocarbon residue can be a linear, branched or cyclic alkylene residue. The hydrocarbon residue can be saturated or unsaturated. R is preferably a divalent hydrocarbon residue having 1 to 6 carbon atoms. The curing rate of the composition can be influenced by the length of the hydrocarbon residues which form one of the binding links or the binding link between polymer backbone and silyl residue. Particularly preferably, R is a methylene, ethylene or n-propylene group, in particular a methylene or n-propylene residue.

Alkoxysilane-terminated compounds having a methylene group as binding link to the polymer backbone—so-called “alpha-silanes”—have a particularly high reactivity of the terminating silyl group, leading to reduced setting times and thus to very rapid curing of formulations based on these polymers.

In general, a lengthening of the binding hydrocarbon chain leads to reduced reactivity of the polymers. In particular, “gamma-silanes”—which comprise the unbranched propylene residue as binding link—have a balanced ratio between necessary reactivity (acceptable curing times) and delayed curing (open assembly time, possibility of corrections after bonding). By carefully combining alpha- and gamma-alkoxysilane-terminated building blocks, therefore, the curing rate of the systems can be influenced as desired.

Within the context of the present invention, R is most particularly preferably an n-propylene group.

The substituents X, Y and Z are, independently of one another, selected from the group consisting of a hydroxyl group and C1 to C8 alkyl, C1 to C8 alkoxy, and C1 to C8 acyloxy groups, wherein at least one of the substituents X, Y, Z here must be a hydrolysable group, preferably a C1 to C8 alkoxy or a C1 to C8 acyloxy group to allow for moisture curing. Substituents X, Y and Z are directly bound with the Si atom or the two of the substituents X, Y, Z form a ring together with the Si atom to which they are bound. In preferred embodiments, X, Y and Z are the substituents directly bound with the SI atom. As hydrolysable groups, preferably alkoxy groups, in particular methoxy, ethoxy, i-propyloxy and i-butyloxy groups, are selected. This is advantageous, since no substances which irritate mucous membranes are released during the curing of compositions comprising alkoxy groups. The alcohols formed by hydrolysis of the residues are harmless in the quantities released and evaporate. These compositions are therefore suitable in particular for the DIY sector. However, acyloxy groups, such as an acetoxy group —O—CO—CH3, can also be used as hydrolysable groups.

In preferred embodiments, the alkoxy- and/or acyloxysilane-terminated polymer(s) has/have at least two terminal groups of the general formula (III). Each polymer chain thus comprises at least two linking points at which the condensation of the polymers can be completed, splitting off the hydrolyzed residues in the presence of atmospheric moisture. In this way, regular and rapid crosslinkability is achieved so that bonds with good strengths can be obtained. In addition, by means of the quantity and the structure of the hydrolysable groups—for example by using di- or trialkoxysilyl groups, methoxy groups or longer residues—the configuration of the network that can be achieved as a long-chain system (thermoplastics), relatively wide-mesh three-dimensional network (elastomers) or highly crosslinked system (thermosets) can be controlled, so that inter alia the elasticity, flexibility and heat resistance of the finished crosslinked compositions can be influenced in this way.

In preferred embodiments, in the general formula (III), X is preferably an alkyl group and Y and Z are, each independently of one another, an alkoxy group, or X, Y and Z are, each independently of one another, an alkoxy group. In general, polymers comprising di- or trialkoxysilyl groups have highly reactive linking points which permit rapid curing, high degrees of crosslinking and thus good final strengths. The particular advantage of dialkoxysilyl groups lies in the fact that, after curing, the corresponding compositions are more elastic, softer and more flexible than systems comprising trialkoxysilyl groups. They are therefore suitable in particular for use as sealants. In addition, they split off even less alcohol during curing and are therefore of particular interest when the quantity of alcohol released is to be reduced.

With trialkoxysilyl groups, on the other hand, a higher degree of crosslinking can be achieved, which is particularly advantageous if a harder, stronger material is desired after curing. In addition, trialkoxysilyl groups are more reactive and therefore crosslink more rapidly, thus reducing the quantity of catalyst required, and they have advantages in “cold flow”—the dimensional stability of a corresponding adhesive under the influence of force and possibly temperature.

Particularly preferably, the substituents X, Y and Z in the general formula (III) are, each independently of one another, selected from a hydroxyl, a methyl, an ethyl, a methoxy or an ethoxy group, at least one of the substituents being a hydroxyl group, or a methoxy or an ethoxy group, preferably a methoxy group. Methoxy and ethoxy groups as comparatively small hydrolysable groups with low steric bulk are very reactive and thus permit a rapid cure, even with low use of catalyst. They are therefore of particular interest for systems in which rapid curing is desirable, such as for example in adhesives with which high initial adhesion is required.

Interesting configuration possibilities are also opened up by combinations of the two groups. If, for example, methoxy is selected for X and ethoxy for Y within the same alkoxysilyl group, the desired reactivity of the terminating silyl groups can be adjusted particularly finely if silyl groups carrying exclusively methoxy groups are deemed too reactive and silyl groups carrying ethoxy groups not reactive enough for the intended use.

In addition to methoxy and ethoxy groups, it is of course also possible to use larger residues as hydrolysable groups, which by nature exhibit lower reactivity. This is of particular interest if delayed curing is also to be achieved by means of the configuration of the alkoxy groups.

The number average molecular weight Mn of the silane modified polymer is 2000 to 100,000 g/mol (Daltons). For example, the number average molecular weight Mn of the silane modified polymer is 4000 to 100,000, preferably 8000 to 50,000, particularly preferably 10,000 to 30,000 and in particular 5,000 to 25,000 g/mol. These molecular weights are particularly advantageous, since the corresponding compositions have a balanced ratio of viscosity (ease of processing), strength and elasticity.

### EXAMPLES

The following examples are included for purposes of illustration so that the disclosure may be more readily understood and are in no way intended to limit the scope of the disclosure unless otherwise specifically indicated. The proceeding description is meant to be exemplary and it is to be understood that variations and modifications may be employed without departing from the concept and intent of the invention as defined in the following claims.

Measurement of Shore A hardness: The procedure is carried out in accordance with ASTM D2240.

Measurement of mechanical properties (tensile test): The breaking strength, elongation at break, and tensile stress values (modulus of elasticity) are determined by the tensile test in accordance with ASTM D412.

Skin over time: To a weigh dish, add 10-20 g of material and immediately start a timer. While timer is running, test the sample using a metal spatula periodically. Note the time at which the sample no longer transfers to the spatula. This is recorded as the skin over time.

Extrusion Rate: Load material into Semco cartridge and insert a 440 nozzle (101.6 by 3.2 mm). Assemble cartridge in a sealant gun set to 90 psi of pressure. To a tared weigh dish extrude material for 15 seconds. Multiply net weight extruded in 15 seconds by 4 for extrusion rate. Extrusion rate is measured in grams/minute.

Depth of Cure: Fill 10 mm wide by 400 mm long with varied depth curing trough with material. Remove excess material, so top surface of material is flat. Allow to cure for 24 h at 25±2° C./50±5% RH. Remove cured strip of product and clean off uncured portion of material. Measure depth of cured material.

Lap Shear: Apply a bead of adhesive to two 1″×4″ prepared Alclad specimens. Spread the adhesive so that when the two specimens are mated a 322.6 mm\hat{ }2 (0.5 in\hat{ }2) area will be completely covered. Apply 1 mm spacer to one of the specimen. Turn both specimens so that their inside edges so that a 12.7 mm (0.5 in) overlap results when the bonding surfaces are mated. Press mating surfaces together. Cure for 7 days at 25±2° C. and 50±5% relative humidity (RH). Place test specimen in grips of testing machine so that 1″ of each end are within grips so that the long axis of the test specimen coincides with the direction of applied force through the center line of the grip. Test the assembly at a crosshead speed of 10 mm/min until failure. Record load at failure and failure mode.

Tensile Strength and Elongation at Break: Fill a mold with material to prepare a 2 mm thick sheet specimen. Cure for 7 days at 25±2° C. and 50±5% relative humidity (RH). Remove the cured sheet from the mold. Use a die to cut a dumbbell specimen. Use thickness gauge to record thickness across gauge line of specimen. Place specimen in the grips of the testing machine ensuring specimen is centered. Remove slack from specimen by adjusting machine crosshead. Attach elastomeric extensometer to the center of the specimen so that a 25 mm (1 in) gauge length is achieved to measure elongation. Test specimen at a crosshead speed of 500 mm/min. Record the load at break and the percent elongation at break.

Unless otherwise noted moisture curing was conducted in a humidity chamber at 25±2° C., 50±5% relative humidity (RH). Tensile and lap shear samples were cured for 7 days.

### Example 1

A curable composition was prepared as shown in the following Table. Amounts are in grams (g).

| Example 1 Material | Amount |
|---|---|
| OH functional polydimethylsiloxane (PDMS), | 53.8 |
| average Mw 41000 | |
| Ground calcium carbonate¹ | 20.0 |
| Precipitated calcium carbonate² | 20.0 |
| Fumed silica, treated with dimethylsiloxy³ | 0.5 |
| Fumed silica, treated with trimethylsiloxy⁴ | 1.2 |
| Carbon black | 0.5 |
| Hexamethyldisilazane | 1.6 |
| Vinyltrimethoxysilane | 0.4 |
| 3-glycidoxytrimethoxysilane | 1.6 |
| Titanium (IV) diisopropoxide bis(acetylacetonate) | 0.25 |
| Titanium (IV) tert-butoxide | 0.25 |
| Total | 100 |

¹Omyacarb FT FL
²Socal 322
³Wacker HDK H20
⁴Wacker H 2000

The curable composition of Example 1 had the following properties.

| Property | Value |
|---|---|
| skin over time (min) | 25 |
| SEMCO extrusion rate (@90 psi) | 38 |
| depth of cure (mm) | 7.7 |
| lap shear strength (MPa) | 1.3 |
| Lap shear failure mode was | |
| 100% cohesive failure | |
| tensile strength (MPa) | 2.0 |
| elongation at break (%) | 371 |
| Shore A hardness | 16 |

### Example 2

A curable composition was prepared as shown in the following Table. Amounts are in grams (g).

| Example 2 Material | Amount |
|---|---|
| OH functional PDMS, average Mw 41000 | 53.8 |
| Ground calcium carbonate¹ | 20.0 |
| Precipitated calcium carbonate² | 20.0 |
| Fumed silica, treated with dimethylsiloxy³ | 0.5 |
| Fumed silica, treated with trimethylsiloxy⁴ | 1.2 |
| Carbon black | 0.5 |
| Hexamethyldisilazane | 1.6 |
| Vinyltrimethoxysilane | 0.4 |
| 3-glycidoxytrimethoxysilane | 1.6 |
| Titanium (IV) diisopropoxide bis(acetylacetonate) | 0.38 |
| Titanium (IV) tert-butoxide | 0.12 |
| Total | 100 |

¹Omyacarb FT FL
²Socal 322
³Wacker HDK H20
⁴Wacker H 2000

The curable composition of Example 2 had the following properties.

| Property | Value |
|---|---|
| Skin over time (min) | 22 |
| SEMCO extrusion rate (@90 psi) | 43 |
| Depth of cure (mm) | 5.0 |
| Lap shear strength (mpa) | 1.0 |
| Lap shear failure mode was | |
| 93% cohesive failure | |
| Tensile strength (mpa) | 2.1 |
| Elongation at break (%) | 381 |
| Shore A hardness | 16 |

### Example 3

A curable composition was prepared as shown in the following Table. Amounts are in grams (g).

| Example 3 Material | Amount |
|---|---|
| OH functional PDMS, average Mw 41000 | 53.8 |
| Ground calcium carbonate¹ | 20.0 |
| Precipitated calcium carbonate² | 20.0 |
| Fumed silica, treated with dimethylsiloxy³ | 0.5 |
| Fumed silica, treated with trimethylsiloxy⁴ | 1.2 |
| Carbon black | 0.5 |
| Hexamethyldisilazane | 1.6 |
| Vinyltrimethoxysilane | 0.4 |
| 3-glycidoxytrimethoxysilane | 1.6 |
| Titanium (IV) diisopropoxide bis(acetylacetonate) | 0.12 |
| Titanium (IV) tert-butoxide | 0.38 |
| Total | 100 |

¹Omyacarb FT FL;
²Socal 322;
³Wacker HDK H20;
⁴Wacker H 2000.

The curable composition of Example 3 had the following properties.

| Property | Value |
|---|---|
| Skin over time (min) | 18 |
| SEMCO extrusion rate (@90 psi) | 45 |
| Depth of cure (mm) | 6.7 |
| Lap shear strength (mpa) | 1.4 |
| Lap shear failure mode was | |
| 99% cohesive failure | |
| Tensile strength (mpa) | 2.0 |
| Elongation at break (%) | 405 |
| Shore A hardness | 16 |

### Example 4

A base composition with no catalyst was prepared as shown in the following Table. Amounts are in grams (g).

| Example 4 Base Composition Material | Amount |
|---|---|
| OH functional PDMS, average Mw 41000 | 48.6 |
| Rheology modifier | 1.0 |
| Ground calcium carbonate¹ | 34.5 |
| Precipitated calcium carbonate² | 9.8 |
| Fumed silica, treated with dimethylsiloxy³ | 0.5 |
| Fumed silica, treated with trimethylsiloxy⁴ | 1.3 |
| Carbon black | 0.5 |
| Hexamethyldisilazane | 1.5 |
| Vinyltrimethoxysilane | 1.0 |
| 3-glycidoxytrimethoxysilane | 1.3 |
| Total | 100 |

¹Omyacarb FT FL;
²Socal 322;
³Wacker HDK H20;
⁴Wacker H 2000.

Different catalysts were added to base composition 4 as shown in the following Tables. Amounts are in grams (g).

### Example 4 Material with Varied Catalyst Combinations

| | Catalyst | 4A | 4B | 4C | 4D | 4E |
|---|---|---|---|---|---|---|
| Base Composition 4 | | 79.6 | 79.6 | 79.6 | 79.6 | 79.6 |
| titanium (IV) | 1 | 0.4 | 0 | 0 | 0 | 0.2 |
| diisopropoxide | | | | | | |
| bis(acetylacetonate) | | | | | | |
| titanium (IV) tert-butoxide | 2 | 0 | 0.4 | 0 | 0 | 0.2 |
| diisobutoxy- | 3 | 0 | 0 | 0.4 | 0 | 0 |
| bisethylacetoacetatotitanate | | | | | | |
| diisopropoxy - | 4 | 0 | 0 | 0 | 0.4 | 0 |
| bisethylacetoacetatotitanate | | | | | | |
| Total | | 80.0 | 80.0 | 80.0 | 80.0 | 80.0 |

| Material | Catalyst | 4F | 4G | 4H | 4I | 4J |
|---|---|---|---|---|---|---|
| Base Composition 4 | | 79.6 | 79.6 | 79.6 | 79.6 | 79.6 |
| Titanium (iv) | 1 | 0.2 | 0.2 | 0 | 0 | 0 |
| diisopropoxide | | | | | | |
| bis(acetylacetonate) | | | | | | |
| Titanium (iv) tert-butoxide | 2 | 0 | 0 | 0.2 | 0.2 | 0 |
| Diisobutoxy- | 3 | 0.2 | 0 | 0.2 | 0 | 0.2 |
| bisethylacetoacetatotitanate | | | | | | |
| Diisopropoxy - | 4 | 0 | 0.2 | 0 | 0.2 | 0.2 |
| bisethylacetoacetatotitanate | | | | | | |
| Total | | 80.0 | 80.0 | 80.0 | 80.0 | 80.0 |

The curable compositions (4A-4J) based on Example 4 Material with varied catalyst combinations added had the following properties, shown below.

| | | Skin | | | |
|---|---|---|---|---|---|
| Sample | Catalyst | over (min) | DOC¹ (mm) | LSS² | TS³ |
| 4A | 1 | 48 | 4.9 | 1.0 | 1.6 |
| 4B | 2 | 42 | 6.2 | 1.4 | 2.0 |
| 4C | 3 | 180+ | 4.0 | 0.7 | did not fully cure |
| 4D | 4 | 180+ | 4.5 | 0.7 | did not fully cure |
| 4E | 1 + 2 | 32 | 6.5 | 1.3 | 1.9 |
| 4F | 1 + 3 | 180+ | 5.3 | 0.7 | did not fully cure |
| 4G | 1 + 4 | 180+ | 5.4 | 0.7 | did not fully cure |
| 4H | 2 + 3 | 149 | 5.8 | 0.9 | did not fully cure |
| 4I | 2 + 4 | 66 | 5.0 | 1.0 | 1.4 |
| 4J | 3 + 4 | 180+ | 5.9 | 0.7 | did not fully cure |

¹depth of cure after 24 hr.
²lap shear strength Mpa
³tensile strength MPa

### Example 5

A curable composition comprising a hydroxy terminated PDMS resin and an amino silane coupler was prepared as shown in the following Table.

| Example 5 Material | Amount (wt. %) |
|---|---|
| OH functional PDMS, average Mw 41000 | 50.5 |
| Ground calcium carbonate | 35.6 |
| Precipitated calcium carbonate | 10 |
| Hexamethyldisilazane | 1.5 |
| Vinyltrimethoxysilane | 0.9 |
| Aminopropyltrimethoxysilane | 0.5 |
| Titanium (IV) diisopropoxide | 0.25 |
| bis(acetylacetonate) | |
| Titanium (IV) tert-butoxide | 0.75 |
| Total | 100 |

The curable composition of Example 5 had the following properties.

| Property | Value |
|---|---|
| Skin over time (min) | 29 |
| extrusion rate (@90 psi) | 120 |
| Depth of cure (mm) | 3.87 |
| Lap shear strength (MPa) | 1.52 |
| Lap shear failure mode | 88.33 |
| Tensile strength (MPa) | 1.8 |
| Elongation at break (%) | 230.9 |
| Shore A hardness | 37 |

### Example 6

A curable composition comprising a silyl terminated polyurethane resin and an amino silane coupler was prepared as shown in the following Table. Amounts are in wt. %.

| Example 6 Material | Amount (%) |
|---|---|
| Silane modified polyurethane | 47.5 |
| Ground calcium carbonate | 35.6 |
| Precipitated calcium carbonate | 10 |
| Fumed silica, treated with | 3 |
| dimethyldichlorosilane | |
| hexamethyldisilazane | 1.5 |
| vinyltrimethoxysilane | 0.9 |
| aminopropyltrimethoxysilane | 0.5 |
| titanium (IV) diisopropoxide | 0.25 |
| bis(acetylacetonate) | |
| titanium (IV) tert-butoxide | 0.75 |
| Total | 100 |

The curable composition of Example 6 had the following properties.

| Property | Value |
|---|---|
| Skin over time (min) | 51 |
| extrusion rate @90 psi (g/min) | 98.8 |
| Depth of cure (mm) | 4.03 |
| Tensile strength (MPa) | 3.0 |
| Elongation at break (%) | 261.3% |
| Shore A hardness | 62 |

What is claimed:

1. A curable composition, comprising:
a curable material selected from a moisture curable organosiloxane, a moisture curable silane modified polymer and a combination thereof;
a first catalyst comprising one or more of titanium (IV) diisopropoxide bis(acetylacetonate); diisobutoxy-bisethylacetoacetatotitanate; diisopropoxy-bisethylacetoacetatotitanate and combinations thereof; and
a second catalyst comprising titanium (IV) tert-butoxide.

2. The curable composition of claim 1, wherein the curable composition is free of tin and the first catalyst and the second catalyst are present in the composition at a wt. % ratio of 0.05:2.0 to 2.0 to 0.05.

3. The curable composition of claim 1, wherein the curable material comprises a silicone polymer of general formula (I): 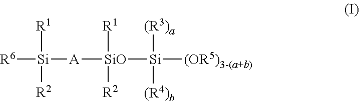
wherein A represents a polymer or copolymer backbone selected from polyurethane, silicone, polyamide, polyether, polyester, and combinations thereof;
R1 and R2 may be the same or different and are monovalent hydrocarbyl groups having up to 10 carbon atoms, or halo- or cyano-substituted hydrocarbyl groups;
R3 and R4 may be the same or different monovalent hydrocarbyl groups and may contain an ethylenically unsaturated polymerizable double bond or a (meth)acryloyl group;
R5 is hydrogen, methyl, ethyl, isopropyl or —CH₂CH₂OCH₃;
a is 0, 1, or 2;
a+b is 1 or 2; and
R6 is a monovalent hydrocarbyl group or:

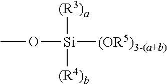

4. The curable composition of claim 3 wherein at least one R3 or R4 is a methacryloxyalkyl group and the first catalyst and the second catalyst are present in the composition at a wt. % ratio of 0.05:1.0 to 1.0 to 0.05.

5. The curable composition of claim 1, wherein the curable material comprises a silicone polymer of general formula (II): 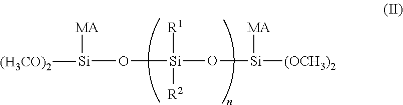
wherein R1 and R2 may be the same or different and are monovalent hydrocarbyl groups having up to 10 carbon atoms, or halo- or cyano-substituted hydrocarbyl groups;
n is from 1 to 1,200; and
MA is a (meth)acryloyl group.

6. The curable composition of claim 1, wherein the curable material comprises OH functional polydimethyl siloxane.

7. The curable composition of claim 1, wherein the curable material comprises a silane modified polymer of the general formula (III) 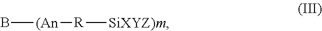
wherein B is a polymer backbone that is not a siloxane;
A is a divalent bonding group containing at least one heteroatom;
R is selected from divalent hydrocarbon residues having 1 to 12 carbon atoms;
X, Y, Z are, independently of one another, selected from a hydroxyl group, C1 to C8 alkyl, C1 to C8 alkoxy, and C1 to C8 acyloxy groups, wherein X, Y, Z are substituents directly bound with the Si atom or two of the substituents X, Y, Z form a ring together with the Si atom to which they are bound, and at least one of the substituents X, Y, Z is selected from the group consisting a hydroxyl group, C1 to C8 alkoxy and C1 to C8 acyloxy groups;
n is 0 or 1; and
m is 1, 2, 3, 4, 5 or 6.

8. The curable composition of claim 7 wherein B is selected from polyether, polyurethane or polyacrylate.

9. The curable composition of claim 1 wherein the first catalyst is selected from the group consisting of titanium (IV) diisopropoxide bis(acetylacetonate); diisobutoxy-bisethylacetoacetatotitanate; diisopropoxy-bisethylacetoacetatotitanate and combinations thereof.

10. An article comprising cured reaction products of the composition of claim 1.

11. Cured reaction products of the composition of claim 1.

12. A method of curing the moisture curable composition according to claim 1, comprising steps of: applying the moisture curable composition onto a surface; and
curing at ambient or elevated temperature for a time and at a relative humidity (RH) sufficient to result in crosslinking via reactions of the moisture curable organosiloxane and/or the moisture curable silane modified polymer catalyzed by the first and/or second catalysts;
wherein the first catalyst and the second catalyst are used in the composition at a wt. % ratio of 0.05:1.0 to 1.0 to 0.05 in the composition.
